(19) United States
(12) Patent Application Publication
(10) Pub. No.: US 2013/0218868 A1
(43) Pub. Date: Aug. 22, 2013

(54) SMART LINKING A FILE TO A PRODUCT

(71) Applicants: James B. Pitts, Toronto (CA); Wayne D. Williams, Monterey, CA (US)

(72) Inventors: James B. Pitts, Toronto (CA); Wayne D. Williams, Monterey, CA (US)

(21) Appl. No.: 13/401,697

(22) Filed: Feb. 21, 2012

(51) Int. Cl. G06F 17/30

(52) U.S. Cl. 707/722; 707/769; 707/E17.014

(57) ABSTRACT

Linking a file with a product. A command to open a file with a file type is detected at a product browser associated with a user device. Available compatible products compatible with the file type and capable of opening the file are searched for, wherein the searching searches, at least in part, for a product that is a self-contained file resolvable by the product browser. A list of the available compatible products is presented at the user device via a user interface associated with the product browser. A selected product is executed via the product browser in response to a selection of the selected product from the list of the available compatible products. The file is opened via the selected product at the user device.

### FIELD OF THE TECHNOLOGY

The present technology relates generally to data processing and computing environments and, more particularly, to system and methods for linking a file to a product.

### BACKGROUND

Today, online purchase and distribution of software is commonplace. Additionally, computers and users are exposed to many different types of files. Each file type may need different products or software for its use or execution. A user, a computer system, or an operating system may not know what type of product is required for a given product or may not know of other available options. Acquiring such knowledge may be time consuming. Additionally, the purchase and deployment of software is not a simple linear process, but includes a number of cycles that occur on an ongoing basis, including installation, provisioning, configuration, updates, bug fixes, and new products purchases, to name a few.

### BRIEF DESCRIPTION OF DRAWINGS

FIG. 1 is a block diagram of a product browser in accordance with embodiments of the present technology.

FIG. 2A is a block diagram illustrating the basic components that comprise the end-to-end lifecycle management system in accordance with embodiments of the present technology.

FIG. 2B is a block diagram illustrating configuration of the system of FIG. 2A to support both public (e.g., Internet-based) and private (e.g., LAN-based) environments in accordance with embodiments of the present technology.

FIG. 2C is a block diagram illustrating the host server presented in FIG. 2B in further detail in accordance with embodiments of the present technology.

FIG. 3 illustrates a flowchart of an example method for linking a file to a product, in accordance with embodiments of the present technology.

FIG. 4 illustrates a flowchart of an example method for linking a file to a product, in accordance with embodiments of the present technology.

The drawings referred to in this description of embodiments should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “detecting,” “searching,” “presenting,” “executing,” “opening,” “setting,” “generating,” “intercepting,” or the like, refer to the actions and processes of a computer system, or similar electronic computing device. The computer system or similar electronic computing device, such as a smartphone, or handheld mobile device, manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, optical and mechanical computers.

### Glossary

The following definitions are offered for purposes of illustration, not limitation, in order to assist with understanding the discussion that follows.

Product: A product is application software used in conjunction with a product browser or an operating system associated with a computer system. The software may be capable of executing on any number of computing devices such as personal computers, server computers, handheld devices, notebooks, netbooks, tablet computers, personal digital assistants, smartphones, etc. The product may also be a native executable application or a self-contained file that is resolvable by the product browser and that is managed, executed, installed, and otherwise operated upon by the product browser. The product may be referred to as an app. In one embodiment, a product can open a file.

Product Browser: A product browser refers to a software application, software module, or code for a client application designed to execute on a computer system or other device. The product browser is capable of installing, executing, caching, managing, and searching for, a product or products as well as other operations in regard to a product. The product browser may be Embarcadero Technologies' ToolBox, AppWave or AppWave browser.

Network: A network is a group of two or more systems linked together. There are many types of computer networks, including local area networks (LANs), virtual private networks (VPNs), wireless networks, metropolitan area networks (MANs), campus area networks (CANs), and wide area networks (WANs) including the Internet. As used herein, the term “network” refers broadly to any group of two or more computer systems or devices that are linked together from time to time (or permanently).

Package: Refers to a collection comprising one or more software modules, including binary executables (e.g., .exe files, under Microsoft Windows) was well as Java packages (e.g., .jar files), C# packages (e.g., files from .NET framework), and the like.

Relational database: A relational database is a collection of data items organized as a set of formally-described tables from which data can be accessed or reassembled in many different ways without having to reorganize the database tables. A relational database employs a set of tables containing data fitted into predefined categories. Each table (which is sometimes called a relation) contains one or more data categories in columns. A feature of a relational database is that users may define relationships between the tables in order to link data that is contained in multiple tables. The standard user and application program interface to a relational database is the Structured Query Language (SQL).

System Administrator: The System Administrator (SA) or simply “administrator” handles tasks that are not specific to applications and works outside the database system's discretionary access control system. System Administrator tasks include: Managing disk storage; Monitoring the database system's automatic recovery procedure; Fine-tuning the database system by changing configurable system parameters; Diagnosing and reporting system problems; Backing up and loading databases; Granting and revoking the System Administrator role; Modifying and dropping server login accounts; Granting permissions to database system users; Creating user databases and granting ownership of them; and Setting up groups which can be used for granting and revoking permissions.

### Overview of Linking a File to a Product

Embodiments of the present technology are for linking a file to a product. Users employ devices or computer systems to open a variety of files. Files may have similar or different file types. Files may be downloaded or otherwise associated with a device. A file typically requires application software, or a product, to open the file. To open a file, with prior solutions, a compatible product must be installed in the operating system of the device or the user must know how to otherwise obtain and install application software that will open the file. This may require knowledge of the file type or extension, where to obtain the application software, and where to obtain a license for the application software. In one example, application software that is compatible with a file may be available to a user, but the user is unaware of the availability. The present technology operates to provide a user with information regarding available and compatible products that will open a file with a given file type. Thus the present technology may fluidly or automatically link a file to a product which may be described as smart linking.

Linking or smart linking a file to a product may occur via a product browser executing on a device or computer system. A computer system may attempt to open a file where the file has a file type or extension. The computer system may be executing an operating system and attempt to open the file in response to a command such as a command from a user. The product browser may operate to detect and/or intercept the command to the file. In one embodiment, the product browser will cross reference the file type with a database, retrieve a list of appropriate products that can open the file, retrieve a list of already installed software applications that can open the file, and present the merged list to the user in a user interface associated with the product browser. The user may then select a desired product to open the file. Upon selection of a product, the product browser is able to fluidly open the file without requiring an additional command or request to re-initiate the opening of the file.

The selected product may be a self-contained file resolvable by the product browser that is capable of immediate execution via the product browser and without requiring installation in an operating system. Thus the user has the ability to immediately open the file regardless of if the application is already installed or not. In one embodiment, the product browser may set a default within the same workflow such that other files with the same file type will be opened by the selected product. In one embodiment, the product browser is capable of obtaining a license for the product that is available to the user and employing the license to execute the product.

In accordance with the present technology, an end-to-end system (commercially embodied as in All-Access™ and ToolCloud™ products/services) is provided for linking a file to a product as well as automating the delivery, licensing, and availability of application software. The system represents the a solution that ties all of these actions together into a single system, which extends all the way from the vendor, to the administrator, and then to the user, all in a fluid delivery cycle that operates on demand. At its core, the system is implemented as a set of services that facilitate delivery, licensing, and availability of software, and also supports on-demand virtualization of software with automated license activation (as described in further detail below).

In an embodiment, the system employs client/server architecture. A “user client” module or product browser is installed at each user's machine and provides a console or “dashboard” that communicates with a host cloud server (ToolCloud™ server), thus forming a closed loop system within which the entire lifecycle is managed. For example, when a new software package is available, the client (user) immediately sees it as the server alerts the client. In one embodiment, the product browser will query the server for changes, updates, or whether a new software package is available. In a similar fashion, when an update is available, it is immediately available to the client (which can then proceed to download the update in the background). Thus in this manner, a multitude of software packages may be placed on the server and be made immediately available to the client. The client in turn may download and install any of the available software packages, or alternatively execute software packages using on-demand virtualization with automated license activation.

The present technology provides for many examples of how linking a file to a product may be used in various environments for a variety of purposes. The following discussion will demonstrate various hardware, software, and firmware components that are used with and in computer systems and other user devices for structuring communications using various embodiments of the present technology. Furthermore, the systems, platforms, and methods may include some, all, or none of the hardware, software, and firmware components discussed below.

### Linking a File to a Product via a Product Browser

Referring to the figures, exemplary embodiments of the technology will now be described. The following description will focus on an embodiment of the present technology, which is implemented using a computer system with desktop and/or server software (e.g., driver, application, or the like) operating in a network-connected environment running under an operating system, such as the Microsoft Windows operating system. The present technology, however, is not limited to any one particular application or any particular environment or platform. Instead, those skilled in the art will find that the system and methods of the present technology may be advantageously embodied on a variety of different platforms, including Macintosh®, Linux®, Solaris®, UNIX®, FreeBSD, and the like. Therefore, the description of the exemplary embodiments that follows is for purposes of illustration and not limitation.

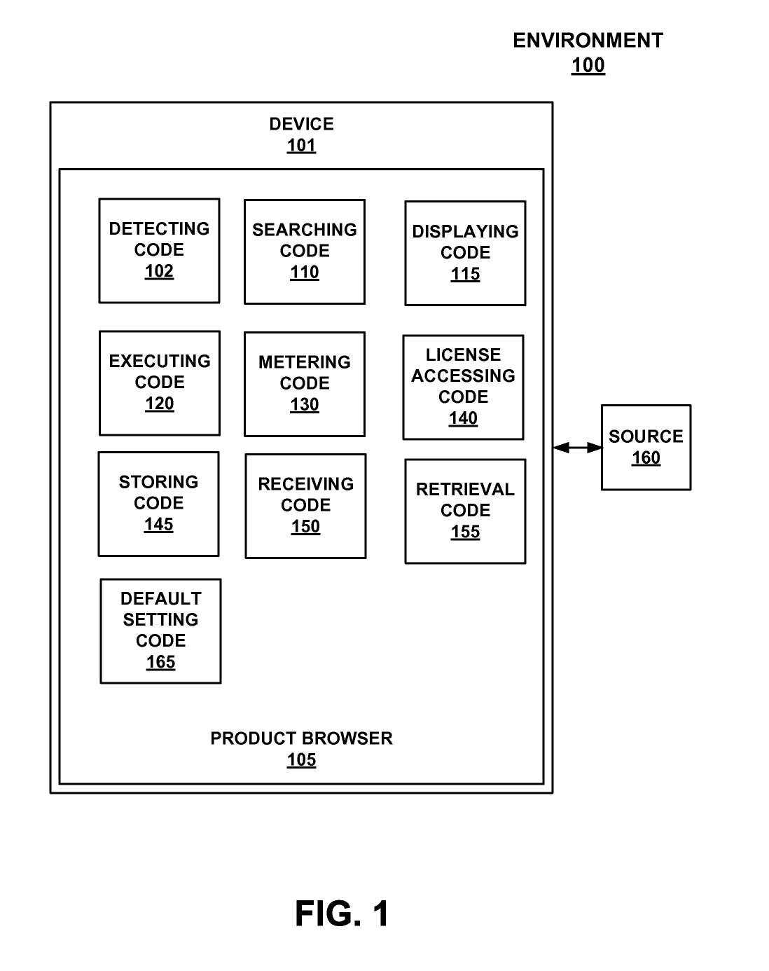

FIG. 1 is a block diagram illustrating environment 100 which is an example environment comprising device 101 and product browser 105 in accordance with embodiments of the present technology. Environment 100 depicts device 101 as a hardware computer system for carrying out the present technology. Product browser 105 is depicted as comprising various components that may or may not be implemented in an embodiment of the present technology.

Product browser 105 may perform smart linking of a file to a product. Smart linking is defined to be searching for and determining software or products that are appropriate to open a file when a command is given to open the file. The smart linking occurs in the product browser and provides a list of optional products to a user and fluidly links the file to a selected product and automatically opens the file with the selected product such that a user is not required to have specific knowledge regarding which products are compatible with the file and which products are available to the user. Additionally, the smart linking operates in the background without requiring a user to specifically request the smart linking.

In one embodiment, device 101 is a computer system that comprises a computer usable storage medium having computer readable program code embedded therein for a product browser such as product browser 105. In one embodiment, product browser 105 has a user interface at device 101 configured for receiving a user selection of a product from source 160. Source 160 may comprise a plurality of products, for execution at device 101. Source 160 may be a database located on hardware that is either privately or publicly accessible. For example, source 160 may be a private database that is owned by an enterprise and only accessible by authorized product browsers. Source 160 may be remotely connected to product browser 105 or may be a local database that is part of device 101. In one embodiment, source 160 comprises installed application software that is installed in an operating system associated with device 101. Product browser 105 may be able to access more than one sources or databases. In one embodiment, the product is a self-contained file resolvable by the product browser. Product browser 105 may comprise a preloaded product for executing within an operating system associated with the device. Product browser 105 may be configured to receive a pushed product pushed from the source.

Product browser 105 may comprise detecting code 102 for detecting a command in an operating system to open a file. The file may be any type of file that is for use with device 101 and requires a product or software application for opening the file. The file may comprise a file type or extension that requires a compatible product to open the file. For example, a file may be of the portable document format (pdf) type. It should be appreciated that there are a wide variety of different file types. File types may also be described as a file format which is the particular way that information is encoded for storage in a computer file. A file type may be identified by metadata associated with the file such as a file extension or filename extension. A filename extension is a suffix usually separated from the filename by a dot. For example, a pdf file with the filename “examplefile” shown with the filename extension is “examplefile.pdf.”

The command to open a file may be initiated by a user or may be issued automatically by another source such as an operating system that automatically issues a command to open a file upon completion of a file download. A command may be initiated by, double clicking on an icon for the file, entering the file name in a run dialog, selecting to run the file from the file's context menu, double clicking an attachment in an email, etc. The command may also be a request to edit the file. Once a command to open a file is detected by product browser 105, searching code 110 may then operate to search for products. In one embodiment, detecting code 102 intercepts the command to open a file and prevents the operating system from executing the command or taking other actions related to the command. The present technology operates fluidly such that a user may not be aware that the product browser has detected or intercepted the command to open a file.

Product browser 105 may comprise searching code 110 for searching for products that are compatible with the file and file type. Thus a compatible product is able to open a given file. In one embodiment, searching code 110 operates automatically after detecting code 102 detects a command to open a file. In one embodiment, searching code 110 only operates if no products or installed application software are currently associated with the file type of the file. In one embodiment, searching code 110 operates in response to a command to search for available products regardless of a command to open a file. Searching code 110 is capable of searching device 101, source 160, or both for compatible products. In one embodiment, searching code 110 searches metadata associated with the products to ensure compatibility of the file and product such as search for metadata indicating that the product is compatible with the filename extension of the file. The metadata may be file extensions, descriptions, versions, editions, system requirements, release date, language type, etc.

In one embodiment, searching code 110 searches source 160 for compatible products that are self-contained files resolvable by the product browser. In one embodiment, searching code 110 searches device 101 for compatible products that are software applications already installed in an operating system associated with device 101. In one embodiment, searching code 110 searches for compatible products that able to open the file and are available to device 101. An available compatible product is a product that is able to open a file upon selection of the available compatible product. This may mean that the available compatible product is installed on device 101 and ready to execute or it may mean that the available compatible product is a native executable application or a self-contained file that is resolvable by product browser 105 and is capable of immediate execution via the product browser and without requiring installation in an operating system. Thus the file may be opened immediately or soon after a product is selected. Available may also mean that a license for the product is available to device 101. For example, device 101 may be part of an enterprise that has a number of licenses for a product.

In one embodiment, searching code 110 searches for more than one version of a product compatible with a file. For example, a file may be a .doc file that may be opened by Microsoft Word 2003 or Microsoft Word 2007. Searching code 110 may identify that both Microsoft Word 2003 and Microsoft Word 2007 are compatible with the .doc file and both are available to device 101.

Product browser 105 may comprise displaying code 115 for displaying a list of the available compatible products identified by searching code 110. Displaying code 115 may display icons, images, graphics, text and other data in a user interface associated with product browser 105. In one embodiment, display code 115 is also capable of receiving a selection of a selected product from the list of available compatible products. In one embodiment, displaying code 115 displays a list of compatible products that merges compatible installed products previously installed on device 101 and remote compatible products from source 160. In one embodiment, display code only display compatible products installed on device 101 or only compatible products from source 160.

Product browser 105 may comprise executing code 120 for executing the product at the device via the product browser. The executing occurs in response to a selection of a product. For example, a user may attempt to open a file; detecting code 102 detects the command to open the file and then initiates searching code 110 to search for compatible products. Display code 115 then displays a list of compatible products and receives a selection of a product. Executing code 120 then executes the product and opens the files. Executing code 120 is also able to determine how to open the file via the selected product. Different files requiring different techniques or command parameters to open the file. For example, some products expect a command parameter to open a file such as “-open” or “/file” the present technology is able to link the file to the selected product including determining how to open the file with the selected product. Upon selection of a product, the product browser is able to fluidly open the file without requiring an additional command or request to re-initiate the opening of the file. Thus the present technology may operate to link a file to a product.

In one embodiment, executing code 120 initiates a product to be executed outside of product browser 105. For example, if a previously installed product is selected to open the file, then the previously installed product may be executed outside of product browser 105 via an operating system associated with device 101. In one embodiment, executing code 120 executes a product via product browser 105. The product executed via product browser 105 may be a previously installed product or may be product selected from source 160. Executing code 120 may execute the product without requiring installation of the product in an operating system associated with device 101. This may be accomplished by using a cache to isolate the product from the operating system. In one embodiment, executing code 120 executes the product using a cache on a storage medium associated with the device 101. Such caching may be referred to as sandboxing the product.

Product browser 105 may comprise default setting code 165 for setting a default product associated with a file type. For example, a user may attempt to open a file that has a pdf file type. The product browser operates to search for compatible products, display the compatible products, receive a selection of a selected product, execute the selected product, open the file with the selected product and set the selected product as a default for opening other files with a pdf file type. The default setting may occur automatically upon the selected product being selected to open a given file type. The default setting may occur upon receiving a command from a user such as the user indicating in the user interface the default selection. The command from the user may be an option in the user interface displayed with the list of compatible products by displaying code 115. Default setting code 165 may be employed to change a default product from a first product to a second product. In one embodiment, default setting code 165 generates a notification that the default product has an updated version and provides an option to obtain the updated version and set it as the default product. Thus the present technology may also operate to link a file type to a product.

Product browser 105 may comprise metering code 130 for tracking a usage of the product via the product browser. The usage information may be employed to filter a list of compatible products to determine whether a particular product is available for a device 101 based on a limited number of licenses available for the particular product. A usage may be how often or for how long a product is executed at device 101. For example, metering code 130 may monitor that a particular app has only been executed once at device 101 after it was initially installed or cached at device 101. Metering code 130 may generate reports based on the usage. Therefore, metering code 130 may provide information that is useful in making decisions about whether a product should remain installed or cached on a given computer system. This is particularly important in a situation where the product is licensed to a limited number of installations. In one embodiment, metering code 130 may operate to prevent the product from executing in response to a license cap being exceeded.

Product browser 105 may also be employed to automatically manage a license associated with the product. The product may be licensed software that requires authorization to install or execute. Such authorization may come in a variety of forms such as a license key, product key, or serial key. Such authorization is not limited to a key. An enterprise or other organization may have only a limited number of licenses that allow only a limited number of instances of the product to be installed or executed by devices owned and operated by the enterprise. Additionally, managing the actual authorization for each instance of the product may be tedious or difficult to effectively maintain. Some user may also under-utilize a product installed or cached on their device and thus deprive another user that ability to use the license for the product.

Product browser 105 solves these problems by automatically managing a license associated with the product. In one embodiment, license accessing code 140 places the proper authorization, such as a key, in the appropriate file or registry location as associated with the operating system of device 101. The appropriate file or registry location is defined by the product. Product browser 105 then manages the license such that the product will activate the license when the user executes the product. Therefore the product will start licensed without requesting licensing input from the user. License accessing code 140 automatically accessing the license for the product from a database of licenses. The database of licenses may be associated with source 160 or a different source. Storing code 145 then stores the license for automatic license activation upon execution of the product. Such storage may take place on a storage medium associated with device 101.

Product browser 105 may operate such that a product may be linked to a file for opening the file. The product may then be streamed from source 160 and may be executed at device 101 by product browser 105 before the product is done streaming. In one embodiment, product browser 105 comprising receiving code 150 for receiving an execution command from the user for the product as well as retrieval code 155 for initiating a streaming retrieval of the product from a source. Executing code 120 then executes the product via the product browser during the streaming before the streaming is complete. Retrieval code 155 may also operate to demand a component or element of the product during the streaming. Such a demand may become necessary based on a required functionality of the product during execution. For example, a user may require a certain functionality of the product that requires components or elements of the product that have not yet been streamed to product browser 105. Thus a product may launch and open a product before the product has been completely streamed to product browser 105.

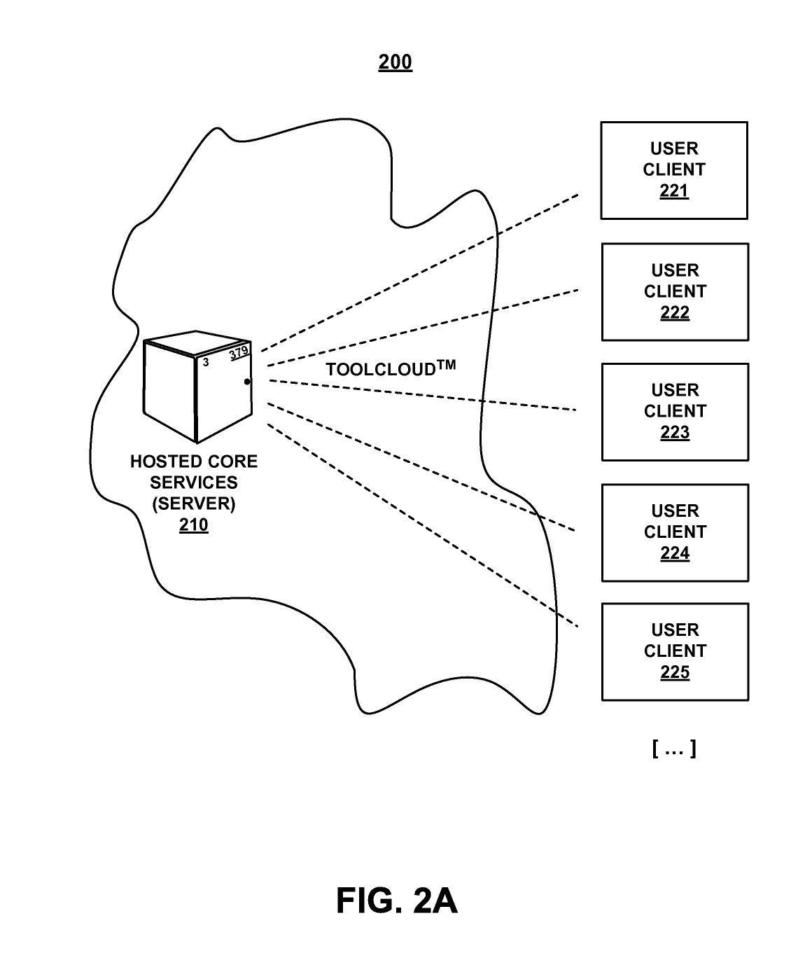

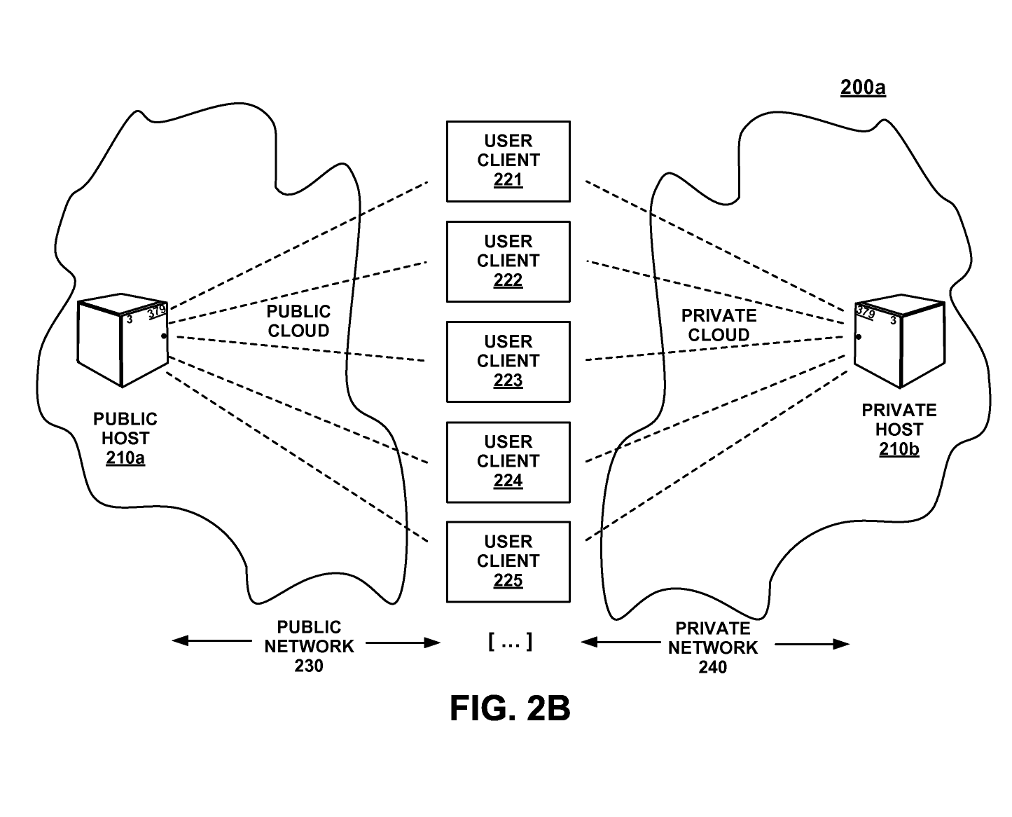

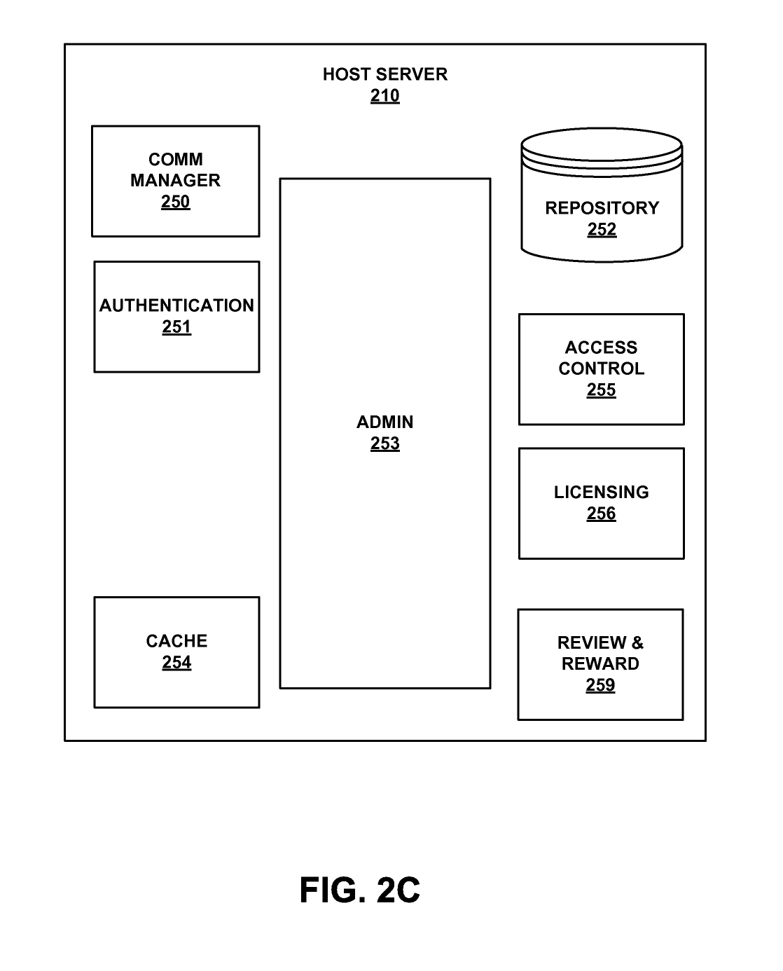

FIG. 2A is a block diagram illustrating the basic components that comprise the ToolCloud™ software lifecycle management system of the present technology. As shown, system 200 includes a plurality of user clients or product browsers, such as user clients 221-225, that connect to a host system (“cloud server”) 210 which provides a ToolCloud™ (i.e., cloud server hosted) environment.

Each user client connects to the host system 210 on a one-to-one basis; for example, user client 221 connects to host system 210 on a one-to-one basis for managing the specific software package(s) that user client 221 has licensed, including downloading, installing, licensing, running, and maintaining specific software on a one-to-one basis.

The ToolCloud™ environment itself may be run with both public and private cloud components. FIG. 2B illustrates the system 200 (now 200a) configured in this manner. The public environment represents a publicly-accessible solution available via a public network. As shown, system 200a includes the plurality of user clients 221-225 connecting to a public cloud, that is, connecting to a host system (server) 210a via a public network 230, such as the Internet. Additionally, the user clients 221-225 connect to a private cloud, specifically, the private host system (server) 210b accessible via a private network 240, such as a corporate LAN (local area network). Although the figure illustrates a simplified embodiment having two clouds (i.e., one public and one private), the present technology is not limited in this fashion; instead, a plurality of clouds may be supported. In a typical deployment, the system will include one public cloud and multiple private clouds.

Each private cloud represents a local server deployment inside an organization, for example, placing the host server 210 on site (e.g., as private host 210b), with local administration, for servicing internal clients. In this manner, each private cloud is well-positioned to furnish a firm's users with managed access to all the software that the firm has licensed. Each private cloud includes an application cache that is loaded from media and/or other clouds. Typically, a given private cloud pulls applications into its application cache from the public cloud (e.g., via HTTP communication protocol), thereby allowing the private cloud to offer an up-to-date catalog of applications.

FIG. 2C is a block diagram illustrating the host server 210 in further detail. As shown, the server 210 includes the following modules: a communication (comm) manager or module 250, authentication module 251, repository 252, administration (admin)/configuration module 253, cache module 254, access control manager or module 255, licensing module 256, and review and reward module 259. Each of these will be described in further detail.

The communication manager 250 engages in communication with clients and other servers, via communication traffic on one or more preconfigured ports. The communications manager 250 works in conjunction with the authentication module 251, which authenticates clients wishing to connect to the host server 210. Repository 252 is used as a storage mechanism to store persistent data, including software product information such as versions, updates, configurations, and licensing information. In an embodiment, the repository 252 is implemented using an embedded SQL relational database.

The cache module 254 is a file-based storage for caching products locally (i.e., increases speed of retrieval) and includes versioning features for tracking disparate copies of each product cached. Software products can be made available by streaming binaries over hypertext transfer protocol (HTTP) from ToolCloud to the product browser. Additionally, the software products can be can be copied into the product browser or installed via HTTP. From the network share, a given Product browser may launch an application directly (if the application is set up for instant-on access, described below) or copy (download) the application to the Product browser's local library. Each software product can have multiple versions, and each version in turn can have multiple possible configurations. Thus, each “flavor” (i.e., specific version and specific configuration) of a product can have its own unique “binary” (i.e., binary image on disk). The cache module 254 keeps track of these different binaries.

Access to individual products (i.e., what products are made available to a given product browser) is controlled by the access control manager 255. User credentials are automatically resolved against available licenses. The particular licensing terms that a given product is available under is tracked by the licensing module 256. The module provides a means by which each cloud server can marshal out licensing terms to individual clients (product browsers) and captures usage statistics based on the licensing. This can be done automatically and transparently, thus freeing individual users from the task of license management. Review and reward module 259 captures user reviews of products. The module includes a reward component to give recognition to users under appropriate circumstances, such as rewarding users who provide reviews or upload useful configurations.

Overall administration of the system 210 is controlled via administration (admin)/configuration module 253. The module includes a user interface allowing the system administrator to specify configurations, including a permission model that establishes access rights for users. The administrator can create different client (product browser) configurations and assign each to a particular group of users. Additionally, the administrator uses the interface to load the various software products that will be offered by the system, and enter relevant licensing information for each such product.

### Operations

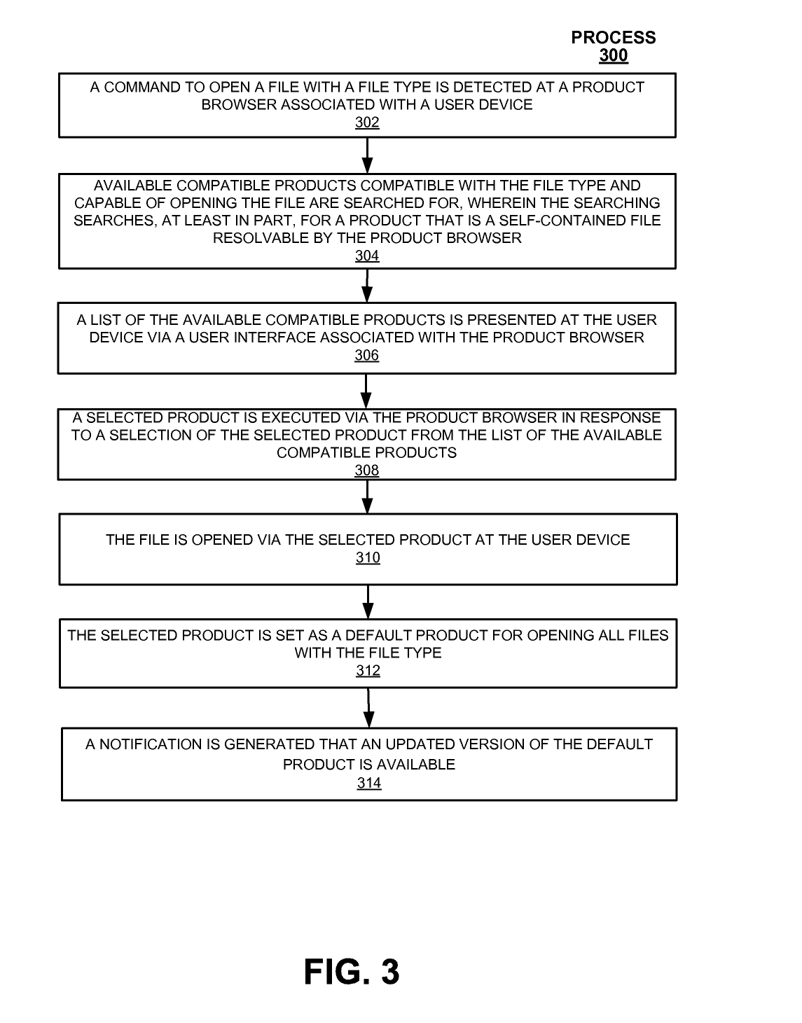

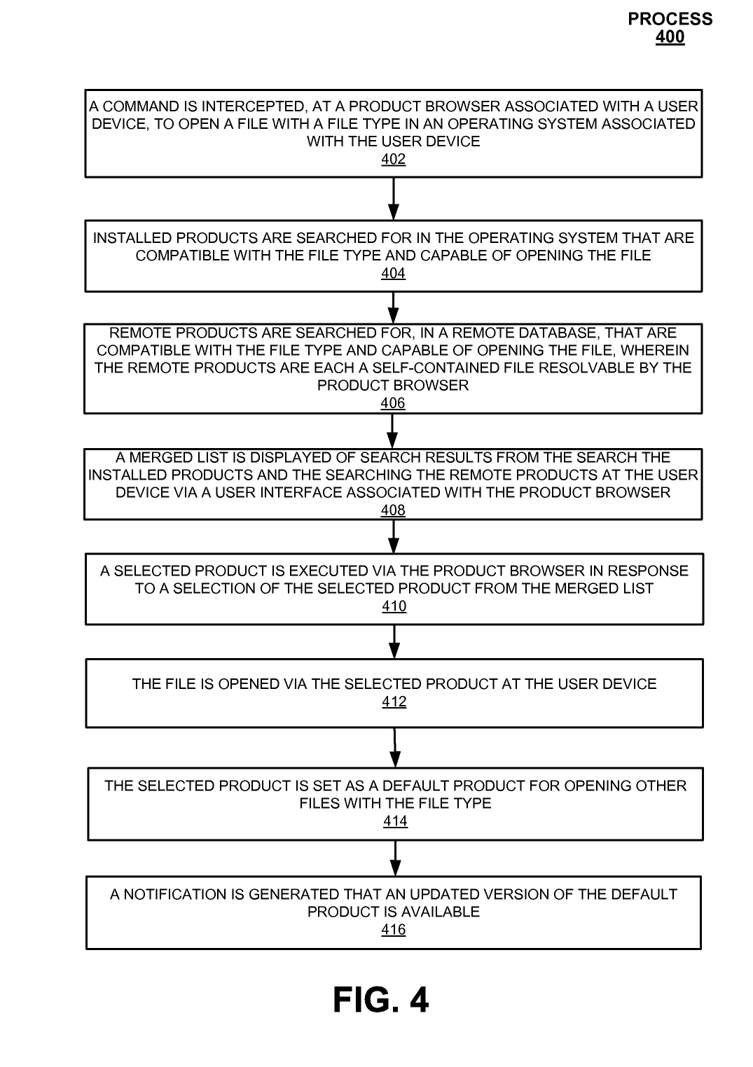

FIGS. 3 and 4 illustrate embodiments for smart linking a product to a file. Smart linking is fluidly linking a file to an appropriate product by searching for and determining software or products that are appropriate to open a file when a command is given to open the file. The smart linking provides a list of optional products to a user and fluidly links the file to a selected product such that a user is not required to have specific knowledge regarding which products are compatible with the file and which products are available to the user.

FIG. 3 is a flowchart illustrating process 300 for linking a file to a product, in accordance with one embodiment of the present invention. In one embodiment, process 300 is carried out, at least in part, by processors and electrical components under the control of computer readable and computer executable instructions stored on a computer-usable storage medium. The computer readable and computer executable instructions reside, for example, in data storage features such as computer usable volatile and non-volatile memory and are non-transitory. However, the non-transitory computer readable and computer executable instructions may reside in any type of computer-usable storage medium. In one embodiment, process 300 is performed by devices and components in FIGS. 1 and 2A-2C.

At 302, a command to open a file with a file type is detected at a product browser associated with a user device.

At 304, available compatible products compatible with the file type and capable of opening the file are searched for, wherein the searching searches, at least in part, for a product that is a self-contained file resolvable by the product browser. The products may be searched for in a database such as a public or private remote database or a local database. In one embodiment, the searching for the available compatible products searches for metadata associated with the available compatible products.

At 306, a list of the available compatible products is presented at the user device via a user interface associated with the product browser. In one embodiment, the presenting the list of the available products presents a merged list of at least one product previously installed on the user device and at least one product from a database. In one embodiment, the list of the available compatible products comprises at least two products of the same type each of a different version. In one embodiment, a list of compatible products is generated and then filtered to include only available products. For example, a computer system may be part of a larger enterprise that has a limited number of licenses for a particular product. The particular product may be search for and discovered as being compatible with the file and thus included in a list of compatible products. However, the list of compatible products may be filtered and determined that the particular product has no available licenses to be used at the computer system, thus the particular product is not included in the filtered list of available compatible products.

At 308, a selected product is executed via the product browser in response to a selection of the selected product from the list of the available compatible products. In one embodiment, the selected product is a self-contained file resolvable by the product browser, and wherein the executing the selected product occurs without requiring installation in an operating system associated with the user device. In one embodiment, the selected product is an installed product previously installed on the user device.

At 310, the file is opened via the selected product at the user device. The selected product may be executed via an operating system associated with the user device or via the product browser. In one embodiment, the file is opened automatically without an additional command to open the file.

At 312, the selected product is set as a default product for opening all files with the file type. The default product may be set automatically or in response to a command. The default product may be changed or the default may be removed.

At 314, a notification is generated that an updated version of the default product is available. In one embodiment, an option to install or cache the updated version of the default product is displayed.

FIG. 4 is a flowchart illustrating process 400 for linking a file to a product, in accordance with one embodiment of the present invention. In one embodiment, process 400 is carried out, at least in part, by processors and electrical components under the control of computer readable and computer executable instructions stored on a computer-usable storage medium. The computer readable and computer executable instructions reside, for example, in data storage features such as computer usable volatile and non-volatile memory and are non-transitory. However, the non-transitory computer readable and computer executable instructions may reside in any type of computer-usable storage medium. In one embodiment, process 400 is performed by devices and components in FIGS. 1 and 2A-2C.

At 402, a command is intercepted, at a product browser associated with a user device, to open a file with a file type in an operating system associated with the user device.

At 404, installed products are searched for in the operating system that are compatible with the file type and capable of opening the file.

At 406, remote products are searched for, in a remote database, that are compatible with the file type and capable of opening the file, wherein the remote products are each a self-contained file resolvable by the product browser. The products may be searched for in a database such as a public or private database or a local database. In one embodiment, the searching for the available compatible products searches for metadata associated with the available compatible products

At 408, a merged list is displayed of search results from the search the installed products and the searching the remote products at the user device via a user interface associated with the product browser. In one embodiment, the merged list is filtered to include only products available to a user of the user device.

At 410, a selected product is executed via the product browser in response to a selection of the selected product from the merged list. In one embodiment, the selected product is one of the remote products, and wherein the executing the selected product occurs without requiring installation in an operating system associated with the user device. In one embodiment, the selected product is one of the installed products. In one embodiment, the selected product requires a license for the executing, and wherein the executing the selected product uses the license accessed from a database of licenses.

At 412, the file is opened via the selected product at the user device. In one embodiment, the file is opened automatically without an additional command to open the file.

At 414, the selected product is set as a default product for opening other files with the file type.

At 416, a notification is generated that an updated version of the default product is available. The product browser may discover the updated version by searching or querying the database. In one embodiment, the updated version is a new version of the default product or a new software package.

While the technology is described in some detail with specific reference to embodiments and alternatives, there is no intent to limit the technology to a particular embodiment or specific alternatives. For instance, those skilled in the art will appreciate that modifications may be made to embodiments without departing from the teachings of the present technology.

### Example Computer System Environment

Portions of the present technology are composed of computer-readable and computer-executable instructions that reside, for example, in computer-usable media of a computer system or other user device such as device 101 of FIG. 1. Described below is an example computer system or components that may be used for or in conjunction with aspects of the present technology such as the ability to run a product browser.

It is appreciated that that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. The computer system is well adapted to having peripheral computer readable media such as, for example, a floppy disk, a compact disc, and the like coupled thereto.

The computer system includes an address/data bus for communicating information, and a processor coupled to bus for processing information and instructions. The computer system is also well suited to a multi-processor or single processor environment and also includes data storage features such as a computer usable volatile memory, e.g. random access memory (RAM), coupled to bus for storing information and instructions for processor(s).

The computer system may also include computer usable non-volatile memory, e.g. read only memory (ROM), as well as input devices such as an alpha-numeric input device, a mouse, or other commonly used input devices. The computer system may also include a display such as liquid crystal device, cathode ray tube, plasma display, and other output components such as a printer or other common output devices.

The computer system may also include one or more signal generating and receiving device(s) coupled with a bus for enabling the system to interface with other electronic devices and computer systems. Signal generating and receiving device(s) of the present embodiment may include wired serial adaptors, modems, and network adaptors, wireless modems, and wireless network adaptors, and other such communication technology. The signal generating and receiving device(s) may work in conjunction with one or more communication interface(s) for coupling information to and/or from the computer system. A communication interface may include a serial port, parallel port, Universal Serial Bus (USB), Ethernet port, antenna, or other input/output interface. A communication interface may physically, electrically, optically, or wirelessly (e.g. via radio frequency) couple the computer system with another device, such as a cellular telephone, radio, a handheld device, a smartphone, or computer system.

Although the subject matter is described in a language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for linking a file with a product, said method comprising:
detecting, at a product browser associated with a user device, a command to open a file with a file type;
searching for available compatible products compatible with said file type and capable of opening said file, wherein said searching searches, at least in part, for a product that is a self-contained file resolvable by said product browser;
presenting a list of said available compatible products at said user device via a user interface associated with said product browser;
executing a selected product via said product browser in response to a selection of said selected product from said list of said available compatible products; and
opening said file via said selected product at said user device.

2. The method of claim 1 further comprising:
setting said selected product as a default product for opening all files with said file type.

3. The method of claim 2 further comprising:
generating a notification that an updated version of said default product is available.

4. The method of claim 1 wherein said searching searches a database of products, where said database is selected from the group of databases consisting of: a public database and a private database.

5. The method of claim 1 wherein said selected product is a self-contained file resolvable by said product browser, and wherein said executing said selected product occurs without requiring installation in an operating system associated with said user device.

6. The method of claim 1 wherein said selected product is an installed product previously installed on said user device.

7. The method of claim 1 wherein said presenting said list of said available products presents a merged list of at least one product previously installed on said user device and at least one product from a database.

8. The method of claim 1 wherein said selected product requires a license for said executing, and wherein said executing said selected product uses said license accessed from a database of licenses.

9. The method of claim 1 wherein said searching for said available compatible products searches for metadata associated with said available compatible products.

10. The method of claim 1 wherein said list of said available compatible products comprises at least two products of a same type each of a different version.

11. A computer-usable storage medium having instructions embodied therein that when executed cause a computer system to perform a method for linking a file with a product, said method comprising:
intercepting a command, at a product browser associated with a user device, to open a file with a file type in an operating system associated with said user device;
searching for installed products in said operating system that are compatible with said file type and capable of opening said file;
searching for remote products, in a remote database, that are compatible with said file type and capable of opening said file, wherein said remote products are each a self-contained file resolvable by said product browser;
displaying a merged list of search results from said search said installed products and said searching said remote products at said user device via a user interface associated with said product browser;
executing a selected product via said product browser in response to a selection of said selected product from said merged list; and
opening said file via said selected product at said user device.

12. The computer-usable storage medium of claim 11 further comprising:
setting said selected product as a default product for opening other files with said file type.

13. The computer-usable storage medium of claim 12 further comprising:
generating a notification that an updated version of said default product is available.

14. The computer-usable storage medium of claim 11 where said remote database of products is selected from the group of databases consisting of: a public database and a private database.

15. The computer-usable storage medium of claim 11 wherein said selected product is one of said remote products, and wherein said executing said selected product occurs without requiring installation in an operating system associated with said user device.

16. The computer-usable storage medium of claim 11 wherein said selected product is one of said installed products.

17. The computer-usable storage medium of claim 11 wherein said selected product requires a license for said executing, and wherein said executing said selected product uses said license accessed from a database of licenses.

18. A computer usable storage medium having computer readable program code embedded therein that when executed causes a device to link a file with a product in a product browser, the program code comprising:
a product browser with a user interface at said device, wherein said file has a file type, said product browser further comprising:
detecting code for detecting a command in an operating system associated with said device to open a file;
searching code for discovering compatible products in a remote database that are compatible with said file type and capable of opening said file, wherein said compatible products are self-contained files resolvable by said product browser;
displaying code for displaying a list of said compatible products that are available to said device via said user interface and for receiving a selection of a selected product, selected from said list of said compatible products; and
executing code for executing said selected product at said device via said product browser without requiring installation of said selected product in said operating system associated with said device and said executing code for opening said file via said selected product, wherein said selected product is selected from said list of said compatible products.

19. The computer-usable storage medium of claim 18, said product browser further comprising:
default setting code for setting said selected product as a default product for opening all files with said file type.

20. The computer-usable storage medium of claim 18, said product browser further comprising:
license accessing code for accessing a license for said selected product, wherein said selected product requires a license for said executing.
